(19) United States
(12) Patent Application Publication
(10) Pub. No.: US 2005/0284429 A1
(43) Pub. Date: Dec. 29, 2005

(54) High efficiency high power internal combustion engine operating in a high compression conversion exchange cycle

(75) Inventor: Michael A.V. Ward, Arlington, MA (US)

Correspondence Address: PERKINS, SMITH & COHEN LLP, ONE BEACON STREET, 30TH FLOOR, BOSTON, MA, 02108, US

(73) Assignee: Combustion Electromagnetics, Inc., Arlington, MA (US)

(21) Appl. No.: 11/097,784

(22) Filed: Apr. 1, 2005

Related U.S. Application Data
(60) Provisional application No. 60/562,500, filed on Apr. 15, 2004.
(60) Provisional application No. 60/558,911, filed on Apr. 2, 2004.

(51) Int. Cl. F02B 75/04

(52) U.S. Cl. 123/48 B

(57) ABSTRACT

A piston 10, a spring operatively coupled to a piston, the spring being inside 21 or outside 41 the piston, and if the spring is inside the piston, the diameter of the spring is equal to 0.7 to 0.9, and if it is outside of the piston it is an external coil spring which is outside the cylinder which contains the piston and is able to provide a force of thousands of pounds per inch, and furthermore so that at light load the compression ratio (CR) is greater than 13 to 1 designated as CR0, at medium load has a compression ratio less then CR0 but greater than CReff, and at wide open throttle (WOT) has a CR equal to Creff, the CR is less than CR0 as would occur at medium or higher load which would lead to a flexing of the spring, and the cycle on the compression stroke is known as the HCX cycle where the pressure goes between Ppre and less than or equal to Pf.

This application claims priority under USC 119(e) of provisional application Ser. No. 60/562,500, filed Apr. 15, 2004; and Ser. No. 60/558,911, filed Apr. 2, 2004.

### FIELD OF THE INVENTION

This invention relates to all spark ignition internal combustion (IC) engines for providing the maximum efficiency available in such engines based on the Otto cycle, by operating such engines at high compression ratios without the harmful effects of excessive high pressures, excessive friction, excessive heat transfer at compression and combustion, and other factors that limit the use of high compression ratio for high engine efficiency. The invention is especially useful for variable air-fuel ratio engines, such as special design spark ignition engines which can run very lean and fast burn at light loads for even higher efficiency, and run at stoichiometry in a homogeneous charge mode for high power without engine knock even when using regular gasoline fuel.

### BACKGROUND OF THE INVENTION AND PRIOR ART

Attempts to increase the efficiency of the IC engine through ultra-lean, fast burn, high compression ratio, have had limited success, principally because of the inability to operate at the high compression ratios needed for highest efficiency. In the case of Diesel engines, high compression ratio (CR) of over 13 to 1 have generally not been successful in increasing efficiency because of the higher friction and heat transfer losses associated with the high CR. That is, above a certain compression ratio, high friction and high heat losses offsets any gains in efficiency due to the higher CR, as pointed out by Komatsu in an SAE paper on the spark ignited Diesel. However, in the case of gasoline engines, when high octane fuel was available, compression ratios of 15 to 1 were used with lean burn to achieve 40% to 50% better fuel economy, as shown by Michael May with his fast burn, lean burn Fireball Engine, reported in a 1979 SAE paper No. 790386. Also, the Ricardo Engineers, England, had some success with their High Ratio Compact Chamber (HRCC) engine operating at a higher CR on high octane fuel, reported in SAE paper No. 810017, 1981.

The main limitation of using high compression ratios with gasoline fuels is engine knock at high load due to the limited octane rating of most fuels. Even with the use of high octane rating fuels such as natural gas, use of high compression ratio has been of limited success, as found by Tecogen Inc., which makes natural gas based co-generation equipment using standard 2-valve gasoline engines converted to natural gas. High CR in the preferred range of 13 to 1 to 18 to 1 by necessity produces high engine cylinder pressures which stress the engine, and with engine knock, can damage the engine. But since an engine operates over a wide range of loads in a real world vehicle, it follows that under light load conditions, where the peak compression and combustion pressures are lower, high CR can be used.

Therefore, considerable work has been done with Variable Compression Ratio (VCR) systems to achieve a high CR at light loads and a low CR and high loads. Generally, they fall into two types: mechanical linkage type, of which there are many, and oil pressurized pistons. Of the mechanical linkage type, U.S. Pat. Nos. 4,517,931 and 6,412,453 are but a sampling. Of the oil-pressurized piston type, U.S. Pat. No. 4,241,705 is an example.

Another approach, which represents an indirect form of VCR, is to use a flexible material within, or connected to the piston, that gives way to limit the peak pressures, as exemplified by U.S. Pat. No. 6,568,357 B1, which uses elastomers, and by my PCT patent application PCT/US03/12058, referred to hence forth as '058, with International Publication No. WO 03/089785 A2 and date of 30 Oct. 2003, which uses preferably metallic springs either in the engine piston or connecting rod to both limit peak pressures at high load and allow for substantial pressures on compression at light loads so that strong air-squish is present to speed up the burn of ultra-lean mixtures. The importance of squish, especially in interacting with flow-coupling ignition sparks, is disclosed in my U.S. Pat. No. 6,267,107 B1, referred to hence forth as '107. The disclosures of my published patent application '058 and patent '107, and other patents, patent applications and published articles cited below, are incorporated herein by reference as though set out at length herein.

While these address but do not exhaust the possible ways of offering VCR systems for handling the issues of engine knock at high CR in gasoline engines, none of them address in detail the more fundamental problem of the Otto cycle for achieving best efficiency and power under all engine operating conditions, from light load where lean burn, fast burn is used at high compression ratio, to high load, where stoichiometric operation, with or without EGR is used, depending on the load requirements, to achieve an engine with highest efficiency, highest power, and low emissions.

Once the problem of lean burn (fast burn) has been solved, as has been done by my company, Combustion Electromagnetics Inc., CEI, as described in an SAE paper No. 2001-01-0548, the next step is to consider higher compression ratios. In our case, this is especially important in view of the fact that in the engine tests we conducted, we found that the lean burn capability of the engine tested (using homogeneous mixtures) was better at higher CR, where it was shown that at approximately 14 to 1 CR, the lean burn capability of the engine was well over the 30 to 1 air-fuel ratio (AFR) of the 11 to 1 CR, around 36 to 1 AFR and higher, depending on CR, also disclosed in my patent application '058. It is believed that this is in part due to the higher squish and turbulence at the higher CR, as well as to the higher adiabatic heating of the ultra lean mixture, to raise it to a relatively higher gas temperature prior to ignition to partly compensate the smaller amount of fuel. That is, the leaner mixture has a lower specific heat Cv at constant volume and a higher specific heat ratio γ, where γ=Cp/Cv, and where Cp is the specific heat at constant pressure.

Finally, for improved ignition means, there can be improved leakage means of an ignition coil where the leakage inductance is minimized. In terms of operation of these improved coils of the ignition system there is disclosed an improved circuit for charging the ignition coils so as to enhance their peak secondary output voltage Vs while returning some of the coil leakage energy-back to the power source by the use of an inductor, a switch and diode.

### SUMMARY AND OBJECTS OF THE PRESENT INVENTION

A new form of high efficiency, high power, low emissions engine based on the Otto cycle, but improving on it, designated “High Compression Conversion Exchange” cycle, or HCX cycle for short, is disclosed, which overcomes the fundamental problem of the Otto cycle. This application discloses in mathematical detail and physical preferred embodiments, simple and optimal ways to use the advantages and benefits of the new HCX cycle to achieve the highest engine efficiency at light loads, and high power at full load, in an otherwise conventional IC engine, preferably in a homogeneous charge spark ignition engine which provides the maximum power at high load and lowest tailpipe emissions through 3-way catalyst action, and best efficiency at light loads through lean burn, fast burn combustion.

The efficiency η of the Otto cycle at a CR designated also as “r”, is given by:
η=1−1/r^{(γ-1)}
so that all other things being equal, the leaner the mixture (γ is highest), and the higher the compression ratio “r”, then the higher the efficiency, where γ=Cp/Cv.

But the Otto cycle suffers from two fundamental problems. One is that the higher the CR, the higher the peak pressure in the engine cylinder, especially at high load, since the cycle requires heat addition at top center of the piston motion at constant volume. Using late burning, with close-to constant pressure, as in the Diesel cycle, or limited pressure, versus constant volume heat addition, compromises efficiency. For a homogenous charge engine this is not practical because of the difficulty of controlling hot spots in the combustion chamber which can cause engine knock by too early uncontrolled ignition.

The other fundamental problem of the Otto cycle engine is that the peak pressure occurs essentially at top center (TC) of the piston stroke, where the component of the force is radially inwards where no work can be done in rotating the engine crank by the high peak pressure Pi and total force Fi on the piston face, to also relieve the high peak pressure. Stated otherwise, the ability to use the high, maximum, available work is at its worst at TC. On the other hand, the ability to do work at 90° crank angle after TC is at a maximum, but the pressure in the cylinder (and the force exerted on the piston face) here is relatively lower.

It is therefore a principal object of the invention to overcome the above disclosed problems of the Otto cycle and provide an engine with a much higher efficiency through use of the HCX system/cycle, which takes the potentially high gas pressure energy at high engine loads associated with a high CR, occurring around TC, and converts it into another recoverable form deliverable later in the cycle. That is, above a certain defined “pre-load pressure” Ppre, heat addition occurs at close-to constant pressure instead of constant volume, by converting the potentially high excess pressure gas energy into another form of stored energy, preferably mechanical spring energy, so that the gas pressure peaks at a “set pressure” Pf, with associated set force Ff and temperature Tf, around TC, well short of the high peak pressures Pi, force Fi, and temperatures Ti of the Otto cycle. In effect, the HCX engine system is designed with a high compression ratio CR0, and takes the potential high pressure excess gas energy around TC at high loads associated with the pressure difference Pi−Pf and converts it to another form of stored energy to partially simulate an engine at a lower and safer CR at high loads but without the losses associated with the lower CR. The system is constructed and arranged to do this in a way that Pf is equal to a safe maximum pressure, approximately equal to that of the engine operating at wide-open-throttle (WOT) with close to 100% volumetric efficiency (ηᵥ), at an effective compression ratio CReff of approximately 9 to 1 or other ratio that does not cause engine knock. The stored energy is recovered and released after the piston has moved to a point where the pressure P(x) starts to fall below Pf, wherein the stored energy is gradually released with minimum dissipation, in a way that it is converted to piston motion and useful work, where x represents the piston axial displacement from TC. The term “approximately” as used herein means within plus or minus 25% of the value it qualifies.

For the preferred embodiment where a steel spring is used to take up the excess force associated with the pressure difference Pi−Pf, the system operates by one or more spring means being further compressed from their pre-loaded compressed position (or elongated if under tension) around top center on the compression stroke due to the gas pressures in the combustion chamber exceeding the pre-load force Fpre, the spring being compressed in relationship to the excess pressure which drops with spring compression due to the gas expansion to attain an equilibrium position, storing the excess pressure as spring energy. The spring energy is then gradually released as the piston moves down and the pressure drops below Pf to the pre-load value Ppre, when the spring recovers to its pre-load position, having converted the potential excess pressure forces related to the high compression ratio occurring around TC, to a later point of crank angle rotation where the potential excess forces can do work in rotating the engine crank while having limited the peak pressures without the usual loss of cycle efficiency which accompanies limited pressure cycles.

The HCX system is further constructed and arranged such that the pressure Pcomp near the end of the compression stroke between 30° and 10° before TC, is approximately equal to the theoretical Otto cycle pressure, i.e. Pcom<Ppre, so that there is little, if any, drop in pressure due to the HCX system at that point, so that, in terms of my patent and patent applications '107 and '058, the high air squish flow is not compromised.

In the typical automotive vehicle case, the engine is designed for 13:1 to 24:1 CR, defined as CR0, with effective CR (CReff) of 8:1 to 11:1 at WOT, or possibly higher for higher octane fuels, but with CReff approximately equal to CR0 at typical driving light load conditions, such as ⅓ of load for a given engine speed. This requires pre-loading of the flexible material in a precise way for a given spring constant k to meet this requirement. The flexible material is preferably spring material, especially of the steel type which has very low loss and can absorb, release, and return over 95% of the energy stored in it.

The pre-loading of the flexible material with the pre-load force Fpre is preferably such as to insure no deflection except at around TC on the compression/combustion stroke. More precisely, in the cases where a pre-loaded spring is used in the moving parts of piston, connecting rod, or other, the spring is pre-loaded such that at the high speed limit of the engine, typically 6000 RPM, no spring deflection occurs from the centripetal force at bottom center (BC) of the engine motion at the engine's high speed limit.

Preferably, the spring is of the disk or wave compression type characterized by a high spring constant of thousands of pounds per inch, as required in the HCX system for a typical gasoline engine with piston diameters in the typical 2.5″ to 4″ diameter, operating at compression ratios above 10 to 1. Preferably, the spring is of the disk or wave type which is contained in the connecting rod under compression to supply a long length of spring with small deflection relative to the longest possible deflection for very long life time in the millions to tens of millions of cycles and higher, depending on application.

The design of the spring for a given “settle” or “set” force Ff, which is typically about 0.6 of Fi, is done as a mathematically arrived at best trade-off between Ff, the spring constant “k”, which is preferably under 20,000 lb/inch, the total spring displacement (mostly pre-load xi), the compression ratios CR0 and CRset defined at WOT stoichiometric engine condition, and other parameters. Typically, this results in a pre-load force approximately ¾ of Ff, which for a typical car engine requires a pre-compressed length of about 2 times h0, where h0 is the clearance height for a flat piston and flat cylinder head at the high engine compression ratio CR0, and the term “about” means within plus or minus 50% of the value it qualifies.

The advantages of the HCX cycle in terms of its higher efficiency and low heat transfer under lean, fast-burn, light load conditions, leads to improved engine designs in any of a number of ways known to those versed in the art, such as using air-cooling instead of water cooling (with higher cylinder wall temperatures) given the lower peak pressures and temperatures, for even lower heat transfer and higher engine efficiency, while providing a simpler and lower cost engine power-plant with less vulnerability to failures. A preferred embodiment of the HCX cycle engine is with the squish-flow, 2-valve, dual ignition engine disclosed in my patent '107 and patent application '058, wherein the engine is designed on the basis of a high compression ratio of approximately 18 to 1 (CR0=18:1), where CRset is approximately 10:1, which improves the engine efficiency under all operating conditions, and particularly under ultra-lean, fast-burn conditions at light load, by providing high compression ratio and high squish flow at the spark plug sites for even leaner and faster burn operation.

An example of a preferred air-cooled HCX engine is one with a spring under tension surrounding the engine cylinder such that the cylinder can move upwards when the force exceeds the pre-load force Fpre. Another is an HCX engine system which uses a spring under compression, preferably disk type, surrounding an extension of the engine cylinder disposed in the engine crankcase, or its equivalent, such that the cylinder can move upwards when the pressure on compression and combustion exceed the pre-load force Fpre. These embodiments are more compatible with electrically actuated valves and 2-stroke engines which do not require a linked connection between the cylinder head and engine crank.

The HCX system allows for an improvement in ignition timing, in that the ignition timing can be set earlier, all other things being equal, since any excess in pressure prior to TC is stored in the spring and recoverable. In this way, a faster burn will occur with peak pressure closer to TC, with the excess energy associated with the pressure difference Pi−Pf stored just after top center.

In the HCX design, it is expected that the total flexible material deflection associated with the energy storage of the HCX system, is significantly greater than the displacement of the piston due to the crank rotation around TC at WOT.

Other features and objects of the invention will be apparent from the following detailed drawings of preferred embodiments of the invention taken in conjunction with the accompanying drawings, in which:

### BRIEF DESCRIPTION OF THE DRAWINGS

FIGS. 1a to 1d represent, in partial schematic side-view form, piston locations at four different crank angle positions.

FIG. 2a represents a Pressure-Volume (P-V) diagram of a conventional gasoline cycle against the more ideal Otto cycle at a high CR. FIG. 2b represents a P-V diagram of the HCX cycle for an otherwise conventional gasoline engine against the more ideal Otto cycle at a high CR. Both are at WOT.

FIGS. 3a and 3b are graphs of simplified piston pressure and velocity relationships during the expansion stroke, as well as the Power produced by the piston from the burnt gasses, for the conventional Otto cycle of FIG. 2a and the HCX cycle of FIG. 2b.

FIG. 4a is a P-V diagram of a conventional engine cycle against the more ideal Otto cycle at a typical CR. FIG. 4b is a P-V diagram of the HCX cycle for an otherwise conventional gasoline engine against the more ideal Otto cycle at a high CR. Both are at WOT.

FIGS. 5a, 5b and 5c represent schematic side views of the piston at and just beyond the top center position defining the clearance and pressure parameters of the HCX cycle.

FIGS. 6a and 6b represent schematic side views of the preferred squish flow type of combustion chamber with the piston just before TC where squish is maximum, and after at a point where the cylinder pressure P(ho+xo) equals the set pressure Pf wherein the outwards flow velocity and heat transfer from the flowing gases to the cylinder head and piston are significantly reduced due to the motion of the piston.

FIG. 7 is a side-view drawing of a piston with an elongated skirt with a flexible material under tension contained between the wrist pin and the bottom end of the piston wherein the temperature is lower than above the wrist pin and more length is available for the flexible material to provide longer life, which allows small relative motion of the piston top relative to the wrist pin when the force on the piston face exceeds the pre-load force Fpre which the spring material is under.

FIG. 8 is a partial side view drawing of a preferred HCX system comprising a spring loaded engine connecting rod for storing the extra combustion energy at high load around TC. FIG. 8a is another form of the connecting rod of FIG. 8 with two coaxial springs to increase the life of the spring and provide greater flexibility of design. These designs are made to accommodate disk or wave type stacked springs, which work only under compression, to provide the high spring constant k of thousands of pounds per inch.

FIG. 9 is a partially schematic side-view drawing of an HCX system comprised of a free standing engine cylinder as could be found in an air-cooled engine with a coil spring able to provide force of thousands of pounds per inch under tension outside the cylinder to allow for small vertically upward movement of the cylinder and cylinder head relative to the piston when the pressure force in the combustion chamber exceeds the pre-load force Fpre.

FIG. 10 is a version of HCX system of FIG. 9 except that a spring is located in the crank case outside of an elongated larger diameter extension of the engine cylinder and is under compression instead of tension to allow for the use of long, large diameter disk type spring means of high spring constant k of thousands of pounds per inch to allow for small vertically upward movement of the cylinder and cylinder head relative to the piston when the pressure force in the combustion chamber exceeds the pre-load pressure Ppre.

FIG. 11 is a partial side-view of a preferred embodiment of an engine using the advantages of the HCX cycle and system in the form of a minimally cooled air-cooled engine which can use any of the HCX flexible systems, especially of FIGS. 7, 9 and 10, with that of FIG. 8 shown, to provide a lightweight, simple, low-cost, high efficiency engine.

FIGS. 12a and 12b represent timing diagrams depicting ignition and combustion burn angles for a standard and the preferred HCX cycle engine.

FIG. 13a is a partial circuit drawing of an improved ignition coil circuit for charging the ignition coils so as to enhance their peak secondary output voltage Vs. FIG. 13b has the feature of returning some of the coil leakage energy back to the power source.

### DISCLOSURE OF PREFERRED EMBODIMENTS

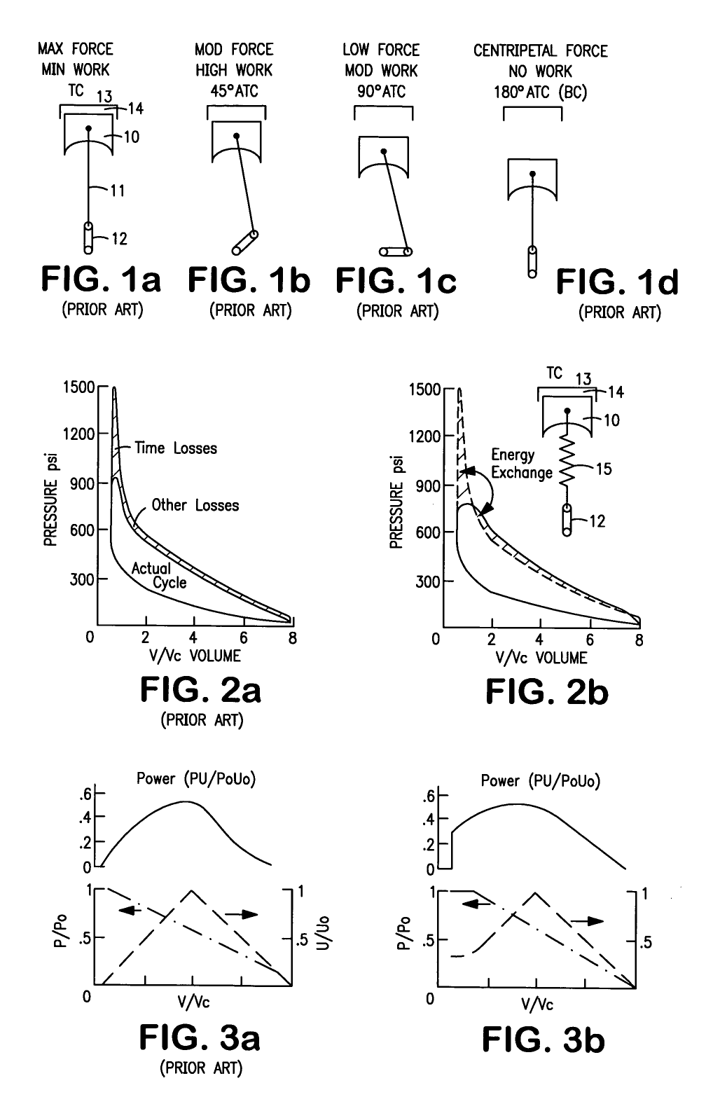

FIGS. 1a to 1d represent, in partial schematic side-view form, piston locations at four different crank angle positions, at TC, at 45° after TC, at 90° after TC, and at 180° after TC. In the drawings, the piston 10 is connected via connecting rod 11 to the crank radius element 12, which work to move the piston through compression, combustion and expansion, and exhaust from the combustion chamber 14 defined between the cylinder head 13 and the piston 10. The engine can be a 2-stroke or 4-stroke engine, a spark ignition or diesel engine, but preferably, and for the purposes of this disclosure, is assumed to be a 4-stroke spark ignition homogeneous charge engine, which more ideally and advantageously can be minimally cooled using air-cooling as a result of the lower heat available from this higher engine efficiency, which preferably operates as a lean burn engine at light loads where most of the driving is done.

FIG. 1a represents one of the fundamental problems of the Otto cycle engine, namely that the combustion gas pressure force is maximum while its ability to do work in rotating the crank is minimum, given the force is vertically downwards (radially inwards). FIG. 1b represents a best compromised location where the force is moderately high and the moment of force about the crank is moderately high for high work to be produced. FIG. 1c represents the case where the ability to do work is maximum but the force is low and the work is moderate. And FIG. 1d represent the piston at bottom center (BC) which is a special case which the HCX system must deal with successfully.

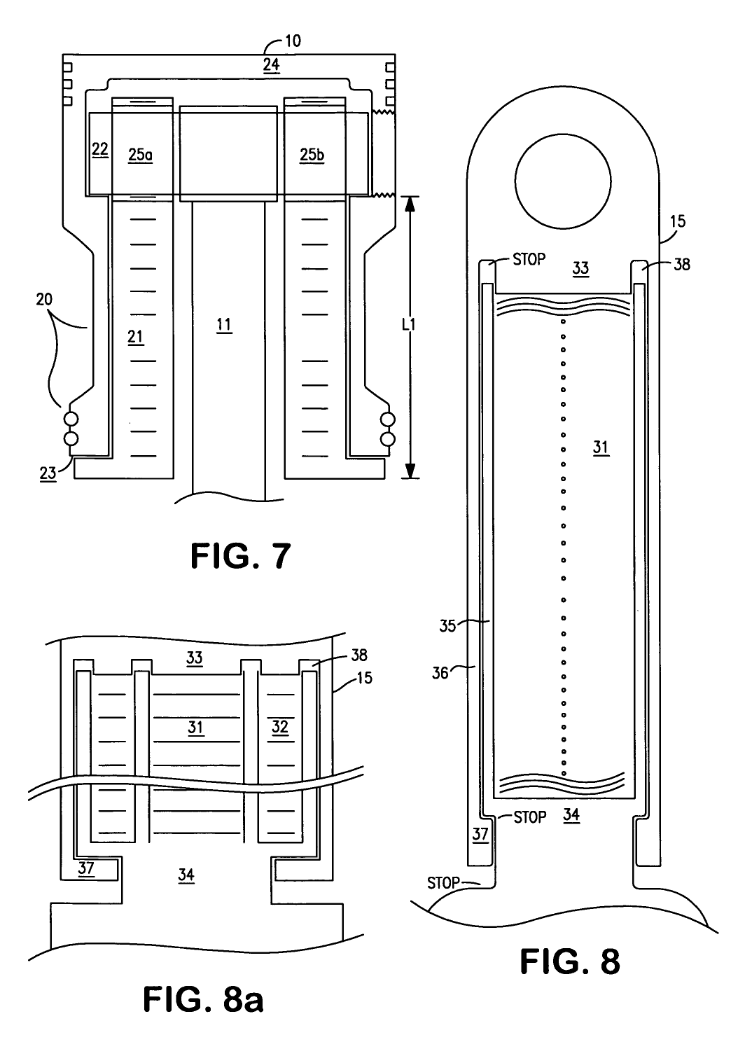

In particular, at BC, there is required a centripetal force on the piston to reverse its downwards motion which will appear as tension of the spring of FIG. 7, and compression of the springs in the connecting rod as in FIGS. 8 and 8a. To prevent motion of the piston, the springs must be pre-loaded to a force greater than the centripetal force Fcent derived below.

For our model, we assume the case of FIG. 8 where a mass weight M of 2 pounds is assumed for the piston and movable outer portion of the connecting rod, and define the engine speed limit Nf as 6,000 RPM. We assume a stroke length S of 3.5″ as representative of a typical larger vehicle (and hence larger force Fcent). The force Fcent is given by:

$$\begin{matrix}Fcent = M * ( S / 2 ) * {( 2 * π * Nf )}^{2} \\ = ( 2 / 32 ) * ( 1.75 / 12 ) * {( 200 * π )}^{2} \\ = 3 , 600 pounds ( lb )\end{matrix}$$

Hence, in the preferred design of such an engine, with an assumed bore diameter of 3.6″ with displacement of 140 cubic inches in a 4-cylinder format, a pre-load force equal to and greater than 3,600 lb is preferred, understanding that in normal driving the engine RPM rarely exceeds 5,000 RPM. And if there is an occasional spring deflection at bottom center, it would be small and rare, and not effect the overall life of the spring.

FIG. 2a represents a Pressure-Volume (P-V) diagram of a conventional gasoline cycle at 90% of WOT, shown with a high peak combustion pressure of approximately 900 psi (pounds per square inch), against the more ideal Otto cycle with a theoretical peak pressure of 1,500 psi for a CR of 15:1, as per the book “The Internal Combustion Engine in Theory and Practice”, by Charles Fayette Taylor, MIT Press, 1965. The reduced peak pressure to 900 psi assumed for the actual engine is due to “time losses”, i.e. completion of combustion well after TC, typically 30° ATC, especially as would be required at high CR. The area enclosed by the smaller closed curve, designated “Actual Cycle”, represents significantly less work done than the larger, more peaked theoretical Otto cycle. The difference in area below the 900 psi level, indicated as “Other Losses”, represents mainly heat transfer losses from the high temperature gas to the surrounding wall and cooling system, and frictional losses. The horizontal axis represents the cylinder volume V divided by the volume Vc at top center.

FIG. 2b represents a P-V diagram of the HCX cycle (solid curve) for an otherwise conventional engine against the more ideal Otto cycle (broken curve) at the same high compression ratio of FIG. 2a. Both curves represent the engine at WOT. In the case of FIG. 2b, the HCX feature is indicated by the schematic similar to FIG. 1a alongside the two P-V curves, except that the connecting rod 15 is assumed to be flexible, preferably made up of compressible spring as per FIG. 8. Like numerals represent like parts with respect to the earlier figures. By being able to store the excess high pressure energy above the HCX cycle maximum of Pf (750 psi shown in the drawing) in the spring, then that energy is released and mostly recovered as the larger area below the HCX peak Pf, to capture most of the Otto cycle work available at the very high compression ratio. In effect, as indicated, the high peak energy is exchanged in the form of lower pressure energy between the dashed curve (Otto cycle) and the wider HCX curve.

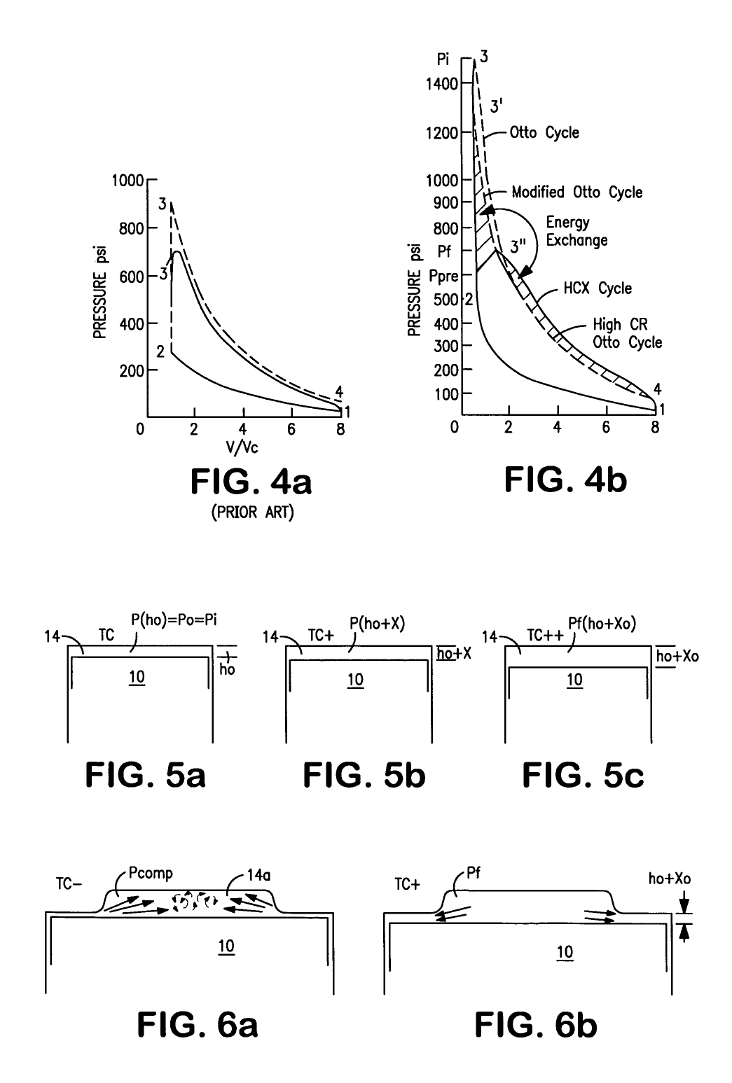

This is indicated by FIGS. 3a and 3b, which are graphs of simplified piston pressure and velocity relationships during the expansion stroke, as well as the Power produced by the piston from the burnt gasses, for the conventional Otto cycle of FIG. 2a (FIG. 3a) and the HCX cycle of FIG. 2b (FIG. 3b). The point to note here is that in the HCX cycle of FIG. 3b, work is done, and power is produced, at the low V/Vc, i.e. around TC, versus no work done in the normal cycle, i.e. the Power curve begins at zero, instead at a high threshold value indicated in FIG. 3b due to the compression FIG. 4a indicates a P-V diagram of a more conventional, lower compression ratio cycle, with two curves, the actual cycle (solid curve) against the more ideal Otto cycle (dashed curve). FIG. 4b indicates a P-V diagram of the HCX cycle for the otherwise same engine of FIG. 4a, indicating the actual HCX cycle (solid curve) with peak indicated set pressure Pf of 750 psi, against the more ideal Otto cycle (broken curve). Both are assumed at WOT.

Visual inspection of the two figures shows the higher work done (areas enclosed by the solid curves) of the HCX cycle (FIG. 4b) than done by the conventional cycle (FIG. 4a). And as with FIG. 2b, we have some of the energy in the modified Otto cycle (discussed later relative to the ideal Otto cycle) above the value Pf (750 psi indicated) delivered to the value below Pf, which shows up as a broader curve, i.e. the high peaked Otto cycle and modified Otto cycle energy (work done) above Pf is converted to lower pressure, more practical energy (work done). The numerals on the curves are as in Taylor's book, 1 representing the initial condition, 2 is the end of the compression stroke, 3, 3′, and 3″ the peak combustion pressure of the ideal and modified Otto cycle and HCX cycle, and 4 is the end of the exhaust stroke.

With these drawings, and the schematic side view drawings of FIGS. 5a, 5b and 5c, which indicate the piston at, and just beyond, the top center position defining the clearance and pressure parameters of the HCX cycle, an analysis of the HCX cycled is disclosed next, which brings out, in detailed mathematical equation and other form, the various features and relationships that comprise the HCX cycle.

Initially following nomenclature from Taylor's book, a basic idea is to design an engine with a high compression ratio, say 15 to 1 as an example, so that the peak Otto cycle pressure at the end of combustion at WOT and stoichiometric AFR, designated as P3(15:1, λ=1) or as Pi, is reduced to a safe knock-free value of 8:1 to 11:1 for gasoline, which is designated as P3(8:1, λ=1) or as Pf for an assumed 8:1 CR, known as CReff or CRset, where λ is the AFR divided by the stoichiometric AFR. From Taylor's book, assuming a volumetric efficiency ηv of 90% at WOT, and assuming the initial pressure P1 is atmospheric (14 psi);
Pi=120*P1*ηv=1,500 psi
Pf=60*P1*ηv=750 psi
where Pi and Pf are fixed, and more generally Pi is a function of AFR and load (ηv).

For simplicity, we assume an automotive type engine with a 3.6″ bore which has a cross-sectional area of 10 square inches, so that cylinder pressure P(x) in psi can be translated to force F(x) in pounds by simply multiplying by 10, understanding that smaller engines will have lower multiplicative factors, and vice vera, which translates to smaller springs for smaller engines, and vice versa.

For the present example:
Fi=15,000 lb
Ff=7,500 lb

If one assumes a stroke “S” of 3.5″, then for the base compression ratio CR0 of 15 to 1 in the present example, one can calculate the clearance height ho as per FIG. 5a as:
ho=S/(CR0−1)=3.5/(14)=0.25″

I now define a force on the piston face for a displacement “x” of piston motion as F(x). The question then is how will the force F(x) change from an initial value F(0) as the piston moves relative to the cylinder head a distance “x”. I derived a particular simple form of an expression assuming adiabatic expansion with a constant “γ” equal to 1.32 at a temperature of approximately 2,000° F., namely:
F(x)=F(0)*ho^{γ}/(ho+x)^{γ}=F(0)*ho/(ho+1.5*x)
which is accurate to within 2% in the range of x values of interest.

Defining xo as the displacement that reduces the WOT force F(0) or Fi to Ff (which is also designated as F(xo)), it follows that for:

$$\begin{matrix}F ( 0 ) = 15 , 000 lb , and for F ( xo ) = 7 , 500 lb , that \text{:} \\ xo = [ ho / 1.5 ] * [ Fi / Ff - 1 ] \\ = ho / 1.5 \\ = {0.167}^{″} in this case .\end{matrix}$$

The force Fs(x) on a spring whose displacement is x, assuming a spring with a linear spring constant k, which has a pre-load displacement “xi”, is given by:
Fs(x)=k*(xi+x)

It follows that the spring must be defined such that:
Ff=Fs(xo)=k*(xi+xo), and
Fpre=Fs(0)=k*xi
k=[Ff−Fpre]/xo
xi=Fpre*xo/[Ff−Fpre]
from which we can determine k and xi once Fi, Ff, Fpre and xo are specified.

Ff has already been specified, and xo has been determined from Fi, so what remains is for Fpre to be specified. Clearly, Fpre must be less than Ff, but as close to Ff as is practical. As a practical matter, there are problems with specifying Fpre to be, say, within 10% of Ff, and a more practical value may be closer to 20% of Ff. Taking Fpre as 0.8 of Ff, i.e. 6,000 lb.
k=[7,500−6,000]*3/[2*ho]=4,500/0.50=9,000 lb/inch
xi=6,000*xo/1,500=4*xo=0.66″
and the total spring displacement, defined as x1, is given by:
x1=xi+xo=4*xo+xo=5*xo=0.833″
which is on the large size for a practical, long life spring.

This satisfies four key conditions. One is to limit “k” to, say, under 20,000 lb/inch. A second is that to limit the pre-load spring displacement, to say, no more than a few times xo. The third is to require that the pre-load force Fpre be greater than the centripetal force Fcent, which in this example was 3,600 lb, which is easily satisfied. And fourth, is to require that Fpre be approximately equal to or greater than the compression force F2 which produces the high squish (see FIG. 6a) under lean burn conditions. Following Taylor, and assuming λ=2, CR0=15:1 in this case, and assuming ηv=100% which represents ½ load, it follows:
P2=36*14=500 psi
F2=5,000 lb
which is less than the pre-load force in this example, as required. This means that for up to 50% load driving condition with a maximum AFR of 30 to 1 for gasoline, one has the full effect of the squish flow, i.e. piston at the end of compression stroke at TC corresponds to the base compression ratio CR0 of 15 to 1.

Up to this point, a factor which determines xo has been ignored, namely that in the operation of the HCX cycle, the peak pressure Pi used to evaluate P(x) is less than that which would be attained in the Otto cycle (see FIG. 4b). As the air-fuel mixture is combusted, the pressure rises at constant volume until it reaches the pre-load value Ppre, where after it rises at closer to constant pressure instead of constant volume, to a potential peak pressure Pi′ (point 3′ of FIG. 4b) less than Pi (point 3), since the specific heat at constant pressure Cp is greater than Cv. The peak pressure Pi′ is related to Pi by:
Pi′=Pi−[Pi−Ppre]*(γ−1)/γ
Hence, the calculation of xo must be corrected accordingly, designated as xo′. Assuming “γ” equals 1.28 at the high temperatures where combustion is completed, for the above example, one obtains (remembering Fi and Fpre are equal to ten times the pressure terms):

$$\begin{matrix}{Fi}^{′} = 15 , 000 - [ 15 , 000 - 6 , 000 ] * .28 / 1.28 \\ \approx 13 , 000 lb \\ {xo}^{′} = [ ho / 1.5 ] * [ ( 13 , 000 / 7 , 500 ) - 1 ] \\ \approx 0.5 * ho \\ = {0.125}^{″} \\ {x1}^{′} = 5 * {xo}^{′} \\ = {0.625}^{″}\end{matrix}$$

which is a more acceptable displacement for the spring.

The spring constant accordingly changes:
k′=k*xo/xo′=9,000*4/3=12,000 lb/inch

From the above, one can calculate the work stored in the spring from the excess pressure compressing the spring, defined as Ws.

$$\begin{matrix}Ws = \begin{matrix}\int k * ( xi + x ) ⅆ x & & with the limits from 0 to {xo}^{′}\end{matrix} \\ = \int [ Fpre + k * x ) ⅆ x \\ Ws = \frac{1}{2} * [ Fpre + Ff ] * {xo}^{′}\end{matrix}$$

Substituting from the above values, we obtain:
Ws=½*[6,000+7,500]*0.125″/12
Ws=70 ft lb.

I derived a simple expression for the energy W(x) that would be released and delivered to the piston in the ideal Otto cycle as the gas expands from TC to any point x, as long as x is less than 2*ho (although an expression for any value of x has also been derived):
W(xo)=xo*Fi*ln[1+1.5*xo/ho]=xo*Fi*ln2
Substituting Fi=15,000, xo=ho/1.5
W(xo)=145 ft lb

Therefore, of the total available excess energy, approximately ½ is transferred to the spring to be delivered as piston motion at WOT. This means that an engine using HCX with a compression ratio CR0 of 15:1 and a peak settling pressure corresponding to a CR of 8:1, called CRset, will have a higher output power than an equivalent engine operating at the set compression ratio CRset (8 to 1 in this example). Furthermore, the effective expansion ratio EReff of the HCX engine at WOT is given by:
EReff=[S/[(ho+xo′)]]+1=3.5/0.375+1=10.3 to 1
in this particular example, which is higher than CRset, which is beneficial.

It should be noted that a more exact analysis should include the centripetal force Fcent at top center (TC) which increases the pre-load force according to the engine speed, i.e. if we define Fcent at its maximum value at its maximum RPM(0) as Fcent(0), then at an arbitrary RPM,
Fcent=Fcent(0)*[RPM/RPM(0)]²
so that in this case, for a typical engine RPM of 2,400 RPM

$$\begin{matrix}Fcent = 3 , 600 * {[ 2 , 400 / 6 , 000 ]}^{2} \\ = 3 , 600 * 0.16 \\ = 576 lb\end{matrix}$$

or under 10% of the pre-load force of 6,000 lb, which is a small correction which will have a negligible effect on the design for non-high speed performance engines.

However, to take this factor into account modifies the basic equation, from which the pre-load is defined, as follows:
Fs(x)=k*(xi+x)+Fcent
which, following the above analysis, results in the more complete equation:
F(x2)=Fi*[1/(1+1.5*x2/ho]=k*[xi+x2]+Fcent
where F(x2) represents the force when the pressure forces and spring forces are in balance.

At this point one has enough information to consider a factor relating to the design integrity of the system. This has to do with the resonant frequency of oscillation “fo” of the spring system. Assuming for simplicity a mass of one pound and a spring constant k of 10,000 lb/inch, we obtain for the resonant frequency:

$$\begin{matrix}fo = [ 1 / ( 2 π ) ] * {[ k / m ]}^{1 / 2} \\ = [ 1 / ( 2 π ) ] * {[ 10 , 000 * 12 * 32 / 1 ]}^{1 / 2} \\ \approx 300 Hz \\ fo = 18 , 000 cycles per minute ,\end{matrix}$$

which is three times the typical top engine speed of 6,000 RPM, and therefore of no concern in the engine operating range in terms of runaway oscillations of the spring system.

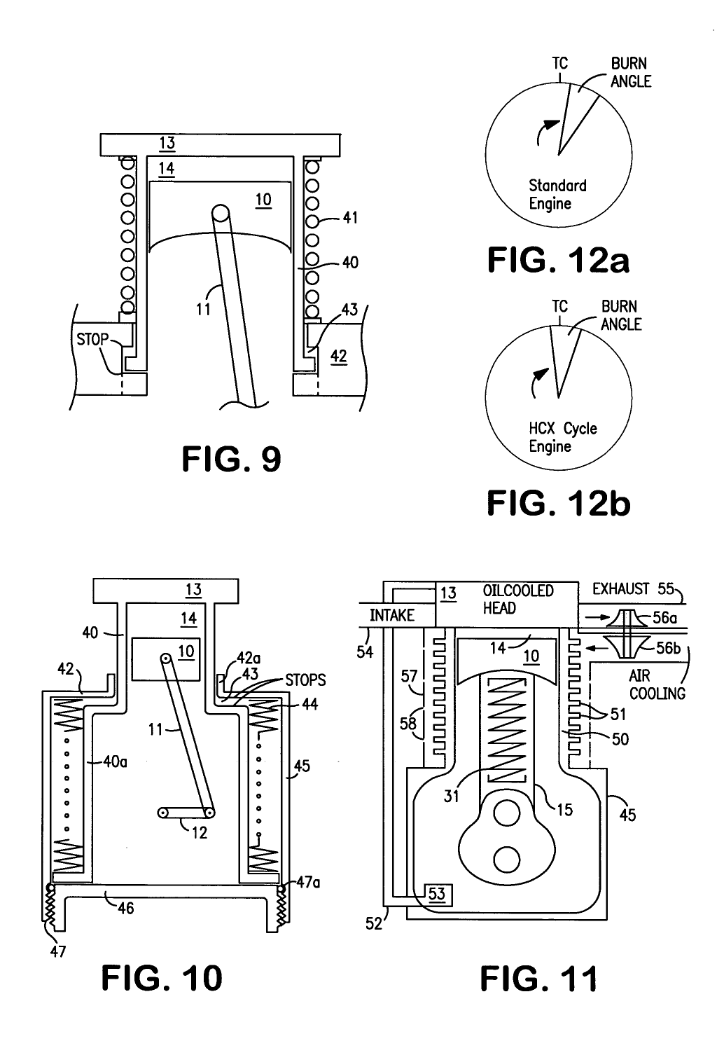

For the systems of FIGS. 9 and 10, where the mass is one to two orders greater, the system resonant frequency could be a problem. But in these cases, the spring constant could be made somewhat greater to partially offset the higher mass. For example, if the mass is 27 lb, we can design the spring with a high spring constant of, say, 30,000 lb/inch, so that the resonant frequency would correspond to 6,000 RPM, which can be set to be above the maximum engine operation of, say, 5,000 RPM. In addition, the chances of knock induced resonant oscillation are lower at high engine RPM. In addition, the high spring constant is associated with a high spring pre-load force Fpre and small displacement xi, so that for an engine operating at wide load condition from very light to WOT, as in a car engine, the occasions where the spring would experience displacement would be rare, i.e. at high loads where an engine may only spend a few percent or less of its time.

There are two pertinent points to emphasize. One is that at high power engine operation the HCX cycle at the high base compression ratio CR0 produces more power than the standard Otto cycle at the lower compression ratio. This implies that for the same maximum power achieved at stoichiometric operation and WOT, one can use significantly higher EGR for the HCX cycle engine for significantly lower NOx emissions than the standard engine, as well as achieving the much higher efficiency at light loads.

The other pertinent point is that even without a detailed rigorous cycle analysis one can conclude that at light loads where the peak pressure Pi is much lower, the effective compression ratio CReff is higher than CRset, and at very light loads where the peak pressure is equal to the pre-load pressure, Pi=Ppre, the effective compression is equal to the base compression ratio CR0 to maximize the light load efficiency.

Using Taylor's book, the peak pressure Pi at λ=2 and CR=15:1 and maximum volumetric efficiency (ηv=1.0) is equal to 90*14=1,260 which represents half engine load. It follows that at an engine load of:
Load=0.5*(Ppre/Pi)=0.5*(6000/1260)=¼ of full load
the effective compression ratio is the base compression ratio CR0 of 15:1.

Comparing the efficiency η for stoichiometric operation at the set CR of 8:1, and ultra lean operation with λ=2 and CR=15:1, then from Taylor's book:
η(8:1, λ=1)=43%
η(15:1, λ=2)=57%
which represents a 33% increase in efficiency ignoring the lower pumping losses and lower heat transfer losses, which can increase the efficiency gain to approximately 50%.

To calculate the effective compression ratio CReff at higher values of light load, e.g. above ¼ load in this example, requires we solve the equation for x1, where x1 represents the spring displacement (less than xo) for a given peak pressure Pi and corresponding force Fi for a given engine operating condition.
Fi=k*[xi+x1]*[1+1.5*x1/ho]
Substituting xo for 2*ho/3, the equation can be re-written to make x1 the subject:
[x1+xi]*[x1+xo]=[Fi/(k*xo)]*xo²
which is a quadratic equation which can be solved for x1. Using the example of neglecting the lower peak pressure Pi′, with xi=4*xo and k=9,000 lb/inch,
[x1+4*xo]*[x1+xo]=[Fi/(k*xo)]*xo2
[x1+2.5*xo]²=[Fi/(k*xo)+2.25]*xo²
x1={[Fi/(k*xo)+2.25]^{1/2}−(2.5)}*xo

As a check, on can substitute Fi=15,000 lb, and k*xo=1,500 lb

x1=[(12.25)^{1/2}−2.5]*xo=[3.5−2.5]*xo=xo as expected.

A higher pre-load force Fpre extends the light load range to higher values where one achieves the light load high efficiency. But this also increases the settling pressure Pf and Force Ff. Therefore, an object of this invention is to use as high a settling force without causing engine knock. High octane fuels such as natural gas and ethanol have an advantage here, as well as engine designs which increase the tolerance for higher compression ratios, especially at low speeds where knock is worse. Such engine designs can include cylinder head design and variable valve timing. In my patent '107 I disclose placing the combustion chamber in the cylinder head, mostly under the exhaust valve, which can increase WOT compression ratio from 9:1 to 11:1, to extend the range of maximum efficiency at light loads by allowing for a higher pre-load force Fpre.

For example, a pre-load pressure Ppre which is approximately ½ of the peak Pi, and a set pressure Pf approximately 0.6 of Pi, is a good design trade-off. With reference to the above example, it would provide the full high Otto cycle efficiency for up to 30% of full load for an air-fuel ratio of 30:1 AFR. Between 30% and 50% of full load, the effective compression ratio CReff would decrease progressively from CR0 to above CRset.

One problem with the design is that as the value of the pre-load force Fpre approaches the value of the set force Ff, the spring constant must accordingly decrease for a given displacement xo or xo′. But to maintain the slightly higher pre-load force Fpre, the pre-load displacement xi must increase. For example, increasing the pre-load force from 6,000 lb to 6,750 lb for a set force Ff of 7,500, i.e. reducing the difference Ff−Fpre by ½ will slightly more than double the pre-load displacement xi (or xi′), granted the spring constant k is halved. But this is a more difficult condition for the spring design.

Therefore, an important object of the present invention is to offer a spring and other related, or combination of, mechanical systems such that a high pre-load force Fpre close to the set force Ff is attained, and once the pre-load force level is met in the engine operation, to have a relatively lower spring constant become active so that the set force Ff is not exceeded. As it turns out, disk springs offer this feature, i.e. drop in k with force and deflection, so that with proper design, the slope change of k(x) versus x can be made to take place at essentially xi′.

FIG. 7 is a side-view drawing of a piston 10 with an elongated skirt 20 with a flexible material 21 under tension contained between the wrist pin 22 and the bottom end of the piston 23, wherein the temperature is lower than above the wrist pin, and more length L1 is available for the flexible material to provide longer life of the flexible material, which allows small relative motion of the piston top 24 relative to the wrist pin 22 when the force on the piston face exceeds the pre-load force Fpre which the flexible material is under. The flexible material can be of any type, preferably of an efficient type with high spring constant k in the order of magnitude of 1000s lb/inch for a typical car engine piston, and proportionally lower and higher depending on the peak piston forces which are proportional to the set pressure Pf and the piston area A. In general, the smaller the piston, the smaller k, and vice versa.

In the figure, the spring 21 is cylindrical, with its outer diameter (OD) close to the inner diameter (ID) of the piston 10, and its ID of small diameter for maximum use of the available volume, but providing enough clearance for the connecting rod 11. As shown in the figure, the spring 21 is attached to the wrist pin 22 via two rings 25a and 25b, intimately attached to the flexible material 21, and molded if the elastic material is a solid, high temperature elastomer.

FIG. 8 is a partial side view drawing of a preferred HCX system comprising a spring loaded engine connecting rod 15 with cylindrical spring 31 for storing the extra combustion energy around TC. FIG. 8a is another partial side view of a form of the connecting rod 15 of FIG. 8 with two coaxial springs 31 and 32, instead of one, to increase the life of the spring and provide greater flexibility of design. These designs are made to accommodate stacked disk springs 31, 32, which work under compression to provide the high spring constant k of thousands of pounds/inch for passenger vehicles, with the desired non-linear k.

The spring 31 in FIG. 8 is compressed and held between the top part 33 of the connecting rod 15 and a bottom part which comprises a tubular section 35 inside of which is the spring and which slides within an outer tubular section 36 which is part of the top part 33 of the connecting rod and has a bottom section 37 which acts as a “STOP” for the inner section 34 to allow for pre-compressing (pre-loading) of the spring. The top section 33 has a small channel 38 of length that is equal to the maximum permissible compression of the spring, i.e. approximately equal to xo, which also act as a “STOP” for the maximum spring compression. The bottom “STOP” section is only a partial cylinder to allow for assembly of the two-part spring loaded connecting rod by compression and twisting to lock the parts together. Operation and assembly of the two spring loaded connecting rod 15 of FIG. 8a is similar to that of FIG. 8, with like numerals representing like parts with respect to FIG. 8. This provides an, in-effect, a longer spring for longer life for a given spring displacement.

FIG. 9 is a partially schematic side-view drawing of an HCX system comprised of a free standing engine cylinder 40 as could be found in an air-cooled engine with an external coil spring 41 able to provide force of thousands of pounds per inch under tension which is located outside the cylinder 40 to allow for small vertically upward movement of the cylinder and cylinder head 13 relative to the piston 10 when the pressure force in the combustion chamber exceeds the pre-load force Fpre. Like numerals representing like parts with respect to the earlier figures.

The cylinder slides inside of a top section 42 of the crankcase, within a slot 43 which provides “STOPS” at two ends to constrain the upward and downward motion of the cylinder to a maximum movement approximately equal to xo′. The slide and constraint means 43 is one of many possible designs for guiding and limiting the travel of the cylinder. In this engine design, the cylinder and head are relatively light weight to accommodate a resonant frequency fo above the operating RPM of the engine. This design is especially useful in applications such as 2-stroke engines where the valves are ported in the cylinder.

FIG. 10 is a version of HCX system of FIG. 9 except that a spring 44 is located in the crank-case 45 outside of an elongated larger diameter extension 40a of the engine cylinder 40 and is under compression instead of tension to allow for the use of long, large diameter disk type spring means of high spring constant k of thousands of pounds per inch to allow for small vertically upward movement of the cylinder and cylinder head relative to the piston, when the pressure force in the combustion chamber exceeds the pre-load force Fpre. Preferably, the pre-load force Fpre is close to the set force Ff, which can be done given the non-linearity of disk springs. Ff is as close to the peak potential force Fi at WOT to limit movement of the cylinder to close to WOT, to both extend the life of the spring and other engine parts. Like numerals represent like parts with respect to the earlier figures.

Shown in the figure is a crankcase base plate 46 which is shown with an engaging thread 47 connecting it to the sidewall of the crankcase 45, with an O-ring oil-seal 47a. By tightening the base plate 46 the spring 44 is pre-loaded to the desired setting. It also allows for easy adjustment of the pre-load force Fpre without having to disassemble the engine. Note that the cylinder 40 is guided by upper crankcase cylindrical extension 42a below which are natural “STOPS”.

FIG. 11 is a partial side-view of a preferred embodiment of an engine using the advantages of the HCX cycle and system in the form of a minimally cooled air-cooled engine which can use any of the HCX flexible systems, especially of FIGS. 7, 9 and 10, to provide a lightweight, simple, low-cost, high efficiency engine. Like numerals represent like parts with respect to the earlier figures.

In this embodiment, the HCX feature is shown as a spring 31 inside the connecting rod 15, as in FIG. 8. The cylinder 50 is shown with cooling fins 51, and the cylinder head 13 is shown fed by oil from a tube 52 connected to the bottom of the crankcase 45 to a pump 53. The oil may provide secondary cooling of the cylinder head. Shown also is an intake 54 and exhaust 55 which preferably may include a turbine 56a connected to a cooling turbine 56b for providing air cooling, which is especially needed at higher engine speeds and loads where there is also excess exhaust pressure. The cooling air enters a shroud 57 and baffling surrounding the cylinder 50 and exits the shroud in properly placed air exhaust outlets 58 to evenly cool the cylinder.

FIGS. 12a and 12b represent timing diagrams depicting ignition and combustion burn angles for a standard and the preferred HCX cycle engine. In the standard engine, FIG. 12a, the burn angle is after top center (TC) in order to insure that at high loads one does not have excessive pressure from occasional fast burn cycles as typically occur due to engine cycle-to-cycle variation. With the HCX cycle engine, the burn angle can be advanced for closer to TC peak pressure, with any occasional excessive pressure taken up by the HCX spring system.

Given the above disclosure, one can develop many more embodiments within the scope of the present invention which realize some or all of the benefits. The present invention enables a new regime of IC engine technology characterized by higher efficiency and higher power, with greater knock control at higher compression ratios.

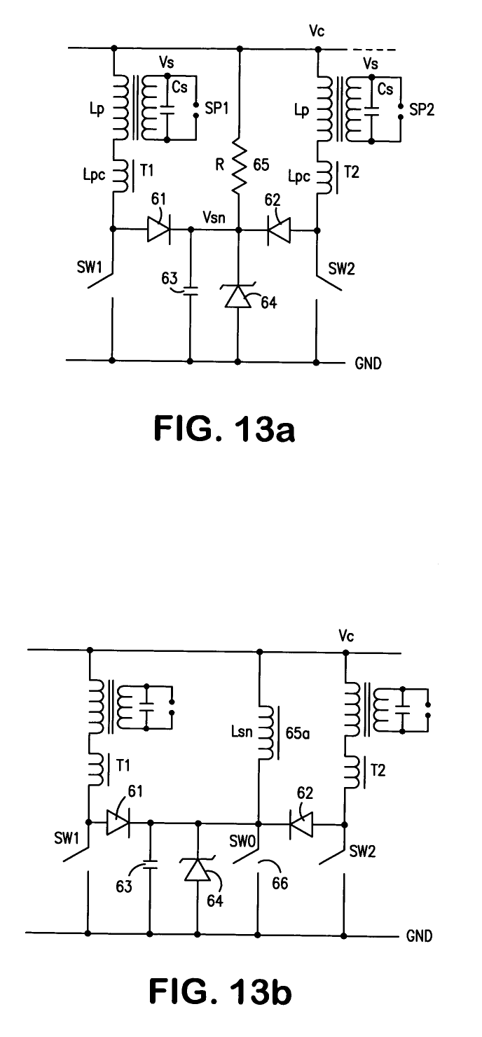

With reference to FIG. 13a, an improvement of the coil high voltage operation of the coil assembly is shown with respect to the two coils T1 and T2, which have high voltage, e.g. 600 volt, isolation diodes 61 and 62 connected above their respective switches Sw1 and Sw2 to a common snubber capacitor 63 across which is a clamp diode 64 (one or more in series and/or parallel combination). The common connection of the cathodes of diodes 61, 62, 64 are connected to a resistor 65 which is connected to the supply voltage Vc. The value of resistor R (65) is such that it discharges capacitor 63 between ignition firings, e.g. R is about equal to 22 K for Cp approximately equal to 0.1 microFarad (uF) for coil assembly with the typical four coils for a four cylinder engine with maximum RPM operation of approximately 6,000 RPM. The term “approximately” means within plus or minimum 25% of the value it qualifies. Snubber capacitor 63 stores the coil leakage inductance (Lpe) energy upon switch opening Sw1, where i=1 to n, and dissipates the energy through resistor 65. However, in this location, it offers the advantage that is shared by the various coils.

FIG. 13a is a partial circuit diagram of an improvement of the coil assembly of FIG. 13a, with the numerals representing like parts with respect to FIG. 13. The advantage provided here is the replacement of resistor 65 with inductor 65a (of inductance Lsn) and the inclusion of switch Sw0 (66) across snubber capacitor 63. After closure, switch 66 is opened synchronously with switches Swi, so that each coil Ti is charged (to be fired) in turn, inductor 65a is charged to a current Isn of typically 1 to 3 amps for an inductance Lsn of a few milliHenry (mH), representing the order of a one to three percent of the energy stored in the coils Ti. The charge time of inductor 65a Tch0 is typically equal to or less than the charge time Tch of switches Swi, as is required to supply the 1 to 3 percent of the coil stored energy, e.g. 2 to 4 mJ for a preferred coil stored energy of 180 mJ.

When switches Swi and Sw0 are opened, energy stored in inductor 65a is available to supplement the coil leakage energy stored on snubber capacitor 63 during charging up of the coil secondary capacitance Cs, so that less energy is depleted from the energy stored in the coil Ti primary. For example, for Lsn approximately equal to 4 mH, and a charge time Tch0 of 100 usecs, and a source voltage Vc of 40 volts, the current at switch opening is approximately 1 amp. Assuming capacitor Csn is charged to 500 volts, the time to discharge the energy stored in the inductor Lsn is approximately 8 usecs, which is in the range of the typical 2 to 10 usecs rise time of voltage Vs for a high voltage range of 10 kV to 40 kV, for the typical low-inductance high energy coils. Therefore, the energy supplemented to Csn helps keep its voltage up, and somewhat raises it to match the transformed output voltage reflected across the primary winding. Once the spark is fired, the energy stored in the snubber capacitor 63 is returned to the energy storage capacitor (with some dissipation), to make for more efficient operation of the ignition. Switches Swi and SW0 are preferably 600 volt IGBT switches.

There are many other possible configurations for the HCX cycle and the HCX cycle engine, with the ones disclosed herein representing some preferred embodiments of such possible configurations. These include the definition and design of the flexible, low loss means, for producing the HCX effect, in terms of designs based on pre-load and set forces, spring constants, expected spring elongation, both pre-load xi′ and actual xo′, from which a properly designed HCX system can be arrived at to provide high efficiency at light loads through high compression ratio and preferably lean burn, and higher power at WOT with controlled and limited pressures.

It should be noted that the HCX cycle can be implemented with a variable compression ratio (VCR) engine, wherein the HCX system would provide instantaneous response to pressure, as opposed to most known VCR systems which, by necessity, have some time-lag. In addition, in such an application, the pressure differences that need to be taken up by the spring systems would be less than without the VCR system, and the VCR system would need to provide a lesser range of variation in the compression ratio.

1. An internal combustion engine or like power delivery system comprising:
(a) a piston of substantially cylindrical cupped form and a compression-combustion-expansion cylinder adapted to contain the piston's reciprocation movement,
(b) a coil spring operatively coupled to the piston,
(c) the coil spring being located inside or outside the piston,
(d) the diameter of the coil spring being equal to 0.7 to 0.9 of piston diameter if the spring is inside the piston, and if it is outside of the piston it is an external coil spring which is outside the cylinder which contains the piston and is able to provide a force of thousands of pounds per inch,
(e) the system being constructed and arranged so that at light load the compression ratio (CR) is greater than 13 to 1 designated as CR_{O} with no elongation or contraction of the spring, at medium load has a compression ratio less then CR_{O} but greater than CReff, where Creff is effective compression ratio and at an assembly operating condition of wide open throttle (WOT) when used in a combustion engine has a CR equal to Creff, the minimum CR, and
(f) the CR being less than CR_{O} as would occur at medium or higher load which would lead to a flexing of the spring, and the cycle on the compression stroke (known as the HCX cycle) being one where the pressure goes between Pre and less than or equal to Pf, where Pre is pre-load pressure value and Pf is peak set pressure.

2. The system of claim 1 wherein the spring is inside the piston and comprises two or more disc springs placed in stacks of “i” springs in single series and comprise more than 50% steel.

3. The system of claim 2 wherein the medium load causes the spring to deflect and the CR to drop to between CR_{O} and CReff, where CReff is between 8 to 1 and 11 to 1, and SW_{O} the combustion chamber is of two valve configuration with squish flow occurring in the combustion chamber.

4. An ignition system with a supply voltage source with at least two ignition coils T1 and T2, with respective switches Sw1 and Sw2 which have high voltage isolation diodes and connected above their respective ignition switches Sw1 and Sw2 to a common snubber capacitor across which is a clamp diode, the common connection of the cathodes of the diodes and being connected to an impedance which is connected to the supply voltage Vc source.

5. The ignition system of claim 4 wherein the impedance is an inductor and has a switch SW_{O} across the snubber capacitor, constructed and arranged so that switch SW_{O} is opened synchronously with the switches associated with the coils, so that as each coil is charged in turn, the inductor is charged to a current of 1 to 3 amps for an inductance of a few milliHenry (mH), representing the order of a one to three percent of the energy stored in the coils.

6. An internal combustion engine or like power delivery system comprising:
(a) a piston of substantially cylindrical cupped form and a compression-combustion-expansion cylinder adapted to contain the piston's reciprocation movement,
(b) a coil spring operatively coupled to the piston,
(c) the coil spring being located inside or outside the piston,
(d) the diameter of the coil spring being equal to 0.7 to 0.9 of piston diameter if the spring is inside the piston, and if it is outside of the piston it is an external coil spring which is outside the cylinder which contains the piston and is able to provide a force of thousands of pounds per inch, the system constructed and arranged so that at light load the compression ratio (CR) is greater than 13 to 1 designated as CR_{O} with no elongation or contraction of the spring, at medium load has a compression ratio less then CR_{O} but greater than CReff, where Creff is effective compression ratio and at an assembly operating condition of wide open throttle (WOT) when used in a combustion engine has a CR equal to Creff, the minimum CR, and
(e) the CR being less than CR_{O} as would occur at medium or higher load which would lead to a flexing of the spring, and the cycle on the compression stroke (known as the HCX cycle) being one where the pressure goes between Pre and less than or equal to Pf, where Pre is pre-load pressure value and Pf is peak set pressure and
(f) providing the ignition system with a supply voltage source with at least two ignition coils T1 and T2, with respective switches Sw1 and Sw2 which have high voltage isolation diodes and connected above their respective ignition switches Sw1 and Sw2 to a common snubber capacitor across which is a clamp diode, the common connection of the cathodes of the diodes being connected to an impedance which is connected to the supply voltage Vc source.
